(19) United States
(12) Patent Application Publication
(10) Pub. No.: US 2003/0061063 A1
(43) Pub. Date: Mar. 27, 2003

(54) Electronic label reading with simultaneous identification of their code

(76) Inventors: Francois Vacherand, Le Pout de Aux (FR); Elisabeth Crochon, Poisat (FR)

Correspondence Address: Hayes Soloway Hennessey, Grossman & Hage, 175 Canal Street, Manchester, NH, 03101, US

(21) Appl. No.: 10/204,099

(22) PCT Filed: Feb. 23, 2001
(86) PCT No.: PCT/FR01/00533

(30) Foreign Application Priority Data
Feb. 25, 2000 (FR) 00/2394

(51) Int. Cl. G06F 17/60

(52) U.S. Cl. 705/1

(57) ABSTRACT

The invention relates to a process for simultaneously reading a set of electronic tags, each comprising a distinct identification code with N bits located within the electromagnetic field of a query device, consisting of:

for each bit rank k, querying all tags to draw up a list of hypothetical codes containing all possible codes for bit rank k, these possible codes being built up starting from bits determined during queries of ranks less than k, and two possible sets of the value of the bits for rank k; and

after each query, producing a real list produced for all tags that responded to the query.

The invention also relates to a system for using this process.

### DOMAIN OF THE INVENTION

The invention relates to a process for simultaneous identification of identification codes of electronic tags located in an electromagnetic field of a query device. The invention also relates to a system designed to use this process.

The invention is generally applicable to any transaction between a query system and responding systems (more simply called “tags”), for which in general neither the number nor the identification codes are known in advance. In particular, the invention is used in applications for the recognition of persons wearing badges, or medical monitoring of persons with implants, or for accounting and checking of objects carrying tags such as baggage in an airport, or products in a production line, or for the management of merchandise stocks. In particular, the invention may be applied to the continuous inventory of the contents of a supermarket caddy in which the purchaser can put down or take out one or several products at any time.

### STATE OF THE ART

An expert in the subject will be familiar with many systems and processes for the identification of objects marked with tags. Most of them are applicable to multiple reading of tags called “multi-tag read”.

Most of these multi-tag read processes offer an option to resend the tag code after a random time specific to each tag, when it is detected that there are collisions between messages sent by the tags simultaneously.

Other processes consist of leaving a particular time slot for the response from a tag. Each time slot is determined univocally by the identification code for each tag. However, these processes do not optimise the transaction time between the query system and all the tags. Furthermore, the time spent by this process to read all the tags may not necessarily be deterministic, since it may be based on drawing random numbers, in addition to the variable number of tags present Furthermore, processes exist that propose systematic and deterministic reading of tag identification codes. One of these processes is described in particular in patent application FR-A-2 677 135. This patent application explains how the query device makes the tags present in the query field of the query device supply each bit of their identification code in sequence, until it has been fully identified. In order to achieve this, the tags respond to a control signal from the query device; when a tag detects that the code being identified is not its own code, it temporarily inhibits itself, in other words it becomes dumb such that the identification cycle continues with the other tags until there is only one tag that is not inhibited. The code for this tag is then identified. At the end of the identification cycle, the identified tag permanently inhibits itself after the query device sends a single command, and the other tags then temporarily clear their inhibition. The identification procedure is then reinitialised to identify another tag. These operations are repeated until all tags have been identified separately. However, this process can only be applied to a static set of tags, that can only be read once. Therefore, it cannot be applied to a dynamic set of tags, in other words tags that can enter and leave the electromagnetic field sent by a query device at random (as in the case of an application for a supermarket caddy).

Furthermore, processes exist that attempt to improve the technique described above by reducing the code acquisition time. One of these processes proposes to reduce the number of messages exchanged between the query device and the tags by using a search tree structure. This process is described in patent application FR-A-2 776 094. In this case, tag identification codes are detected in sequence one after the other.

Neither this process nor any of the other processes known at the present time is capable of simultaneously identifying the identification codes of tags present in the electromagnetic field of the query device. However, simultaneous detection of identification codes would be a means of optimising the acquisition rate of these codes.

### DESCRIPTION OF THE INVENTION

The purpose of the invention is specifically to overcome the disadvantages of the techniques described above. Consequently, it proposes a process for simultaneous identification of identification codes of a set of tags in which the codes of all tags located within the electromagnetic field of the query device are read simultaneously, without the need for the tags to inhibit themselves. Thus, the query device always has the same amount of information on every tag.

More precisely, the invention relates to a process for reading a set of electronic tags, each comprising a distinct identification code with N bits located within the electromagnetic field of a query device; this process is characterized by the fact that it consists of simultaneously identifying the codes of all tags present in the electromagnetic field, by determining the N bits of the identification codes, bit rank by bit rank.

Advantageously, this process consists of:

for each bit rank k, querying all tags following a list of hypothetical codes containing all possible codes for bit rank k, these possible code being built up starting from bits determined during queries of ranks less than k, and two possible sets of the value of the bits for rank k; and

after each query, producing a real list produced for all tags that responded to the query.

According to the preferred embodiment of the invention, for each tag, the real list comprises the code bits determined during queries on ranks less than k, and an order number assigned to each tag.

Advantageously, order numbers are assigned to the tags in sequence one after the other, by the query device.

Preferably, the order numbers of the tags are updated as the bits of identification codes are detected.

According to one embodiment of the invention, the process consists of checking the identification code detected by a call to all previously listed tags, after identification of all tags present in the electromagnetic field.

The invention also relates a read system for using the process described above. In this read system, the tags and the query device each comprise means of sending/receiving signals, and sequencing and storage means. This system is characterised by the fact that the query device comprises means for managing tag queries, bit rank by bit rank, and means of calculating tag order numbers; it is also characterised by the fact that tags comprise means of managing order numbers, and means of storing order numbers.

### BRIEF DESCRIPTION OF THE FIGURES

FIG. 1 shows the functional diagram of the process according to the invention;

FIG. 2 shows the time diagram for information exchanges between the query device and a tag.

FIG. 3 shows an example time diagram related to the call from the query device to six tags;

FIG. 4 shows an example time diagram for the tag verification phase;

FIG. 5 show examples of a tree structure search with the process according to the invention; and

FIGS. 6 and 7 diagrammatically show the system according to the invention.

### DETAILED DESCRIPTION OF EMBODIMENTS OF THE INVENTION

The process according to the invention consists of simultaneously reading identification codes of a set of tags present in the electromagnetic field of the query device. This is done by deciding to take binary identification codes, all different from each other but with the same length, this length being known. It will also be considered in the rest of this description that each identification code of a tag contains N bits.

The process for identification of tag codes according to the invention is made bit rank by bit rank by browsing through a binary search tree in which each branch represents the value 0 or 1 of the N bits, and in which each branch is connected to the branch with the complementary value 0 or 1 through a node.

The search structure may be followed starting from the highest order bit working towards the lowest order bit, or vice versa, the two paths creating two perfectly symmetrical processes.

Therefore, the process according to the invention proposes to determine all bits making up tag codes, bit rank by bit rank, the bit rank being the current position of the bit pointer in the identification codes currently being read.

In each bit rank, the query device globally queries all tags about the value of their bits in this rank. Each tag responds by giving the value of its bit. Two contiguous time intervals are used for this purpose: for a bit equal to 0, the tags send a beep in one of the time intervals, and for a bit equal to 1 the tags send a beep in the other time interval. Two different cases can then arise:

either the values of the bits for this bit rank k are identical, in other words there is no response in one of these intervals: the process then continues on the next bit rank, after having updated the value of the codes by adding or not adding the weight of the bit that has just been determined;

or there are two values of bits, in other words a bit equal to 0 and a bit equal to 1; in this case there is a possibility of a new code; this case is called ambiguity or collision; it will be described in detail in the rest of this description.

In other words, the process according to the invention consists of browsing through the binary structure, bit rank by bit rank, in order to determine whether or not there is a collision of bits, in other words if there is a possibility of a new code. A collision is managed by assigning a distinct order number to each tag or group of tags with the same code start. Order numbers are used to determine the maximum possible number of codes at each bit rank, taking account of all possible assumptions.

In the preferred embodiment of the invention, the order numbers are used to call all tags to eliminate invalid assumptions and therefore to determine the real list of identification codes.

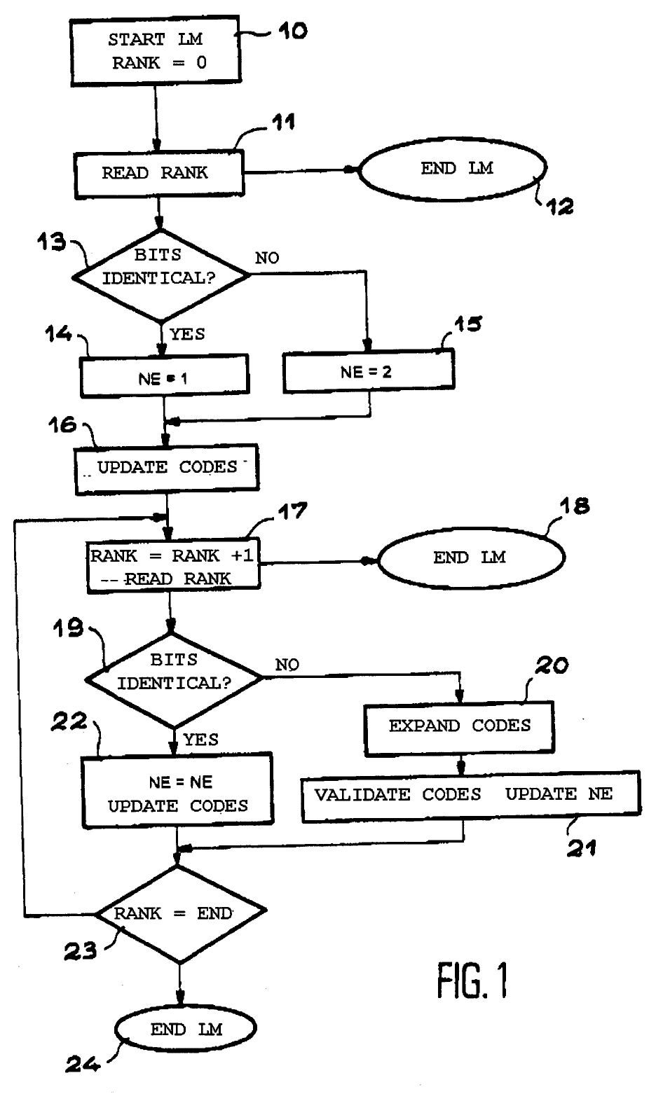

FIG. 1 shows the functional diagram of the process according to the invention. This process begins by a step 10 to command start of the multiple read cycle “LM”. This start command initialises this cycle, in the tags present in the electromagnetic field of the query device at the time that it is sent. A tag that enters the electromagnetic field after this command and before the end of the identification cycle will not participate in this identification cycle. It will remain silent while waiting for a new start read cycle message.

The bit rank is initialised to zero at the time of this start multiple read cycle command.

The process according to the invention continues with a step 11 to read this first rank, implicitly requested in the command 10.

The first bit rank is read by knowing the value(s) of the bit in this first rank, globally for all codes present. Since the codes are binary, there are only two possible values, namely 0 and 1.

When the query device sends a read first bit rank command (step 11), all tags that received the start multiple read command, in other words all tags present in the electromagnetic field at the beginning of the read cycle, can respond by sending a beep for the value 0 or a beep for the value 1. The value 0 or 1 of the beep is given by the time interval during which the tags respond. In other words, in order to reply that the bit for the bit rank reconsidered is equal to 1, the tags send a beep signal in one of the intervals, and to respond that the bit is equal to 1 the tags send a beep signal in the other interval.

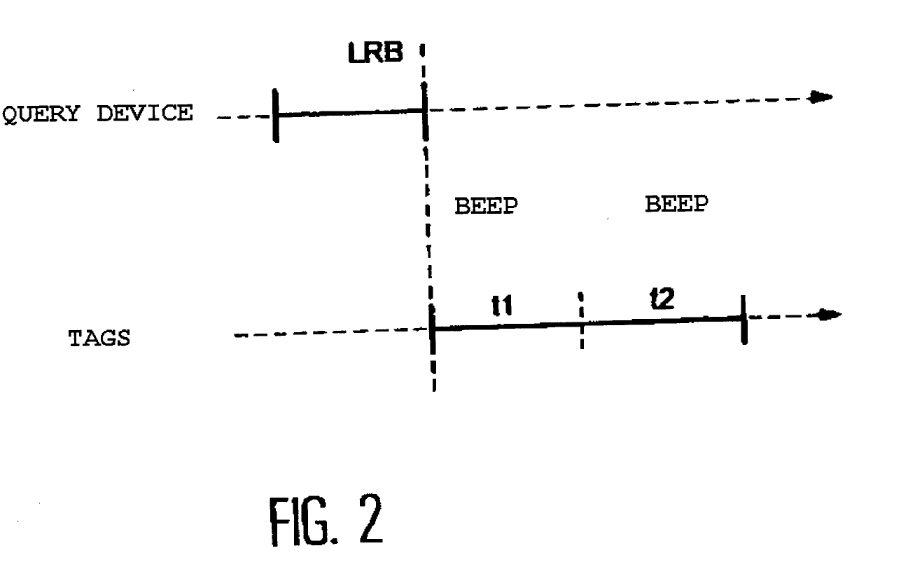

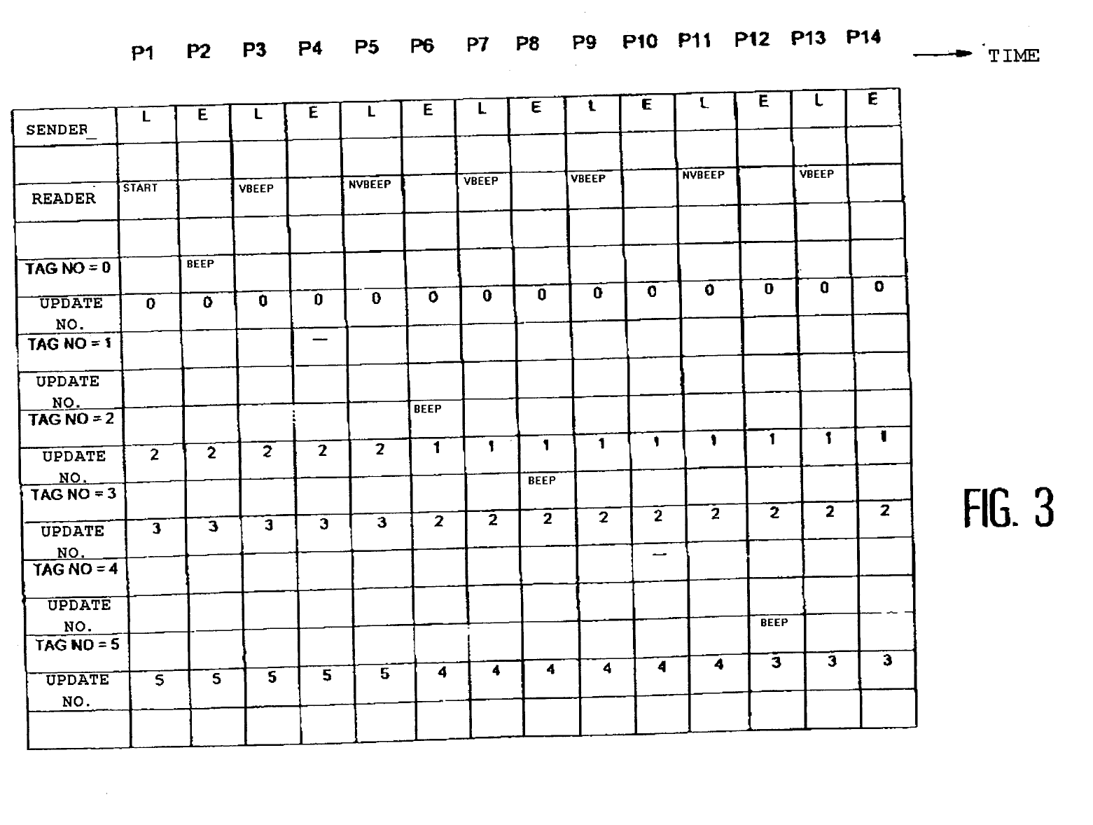

FIG. 2 shows an example of response intervals for a tag E following a read bit rank command from the query device. This FIG. 2 shows that after the read bit rank LRB command sent by the query device, each tag sends either a beep on interval t1 if its bit is equal to 0, or a beep on interval t2 if its bit is equal to 1.

If the query device does not detect any response during interval t1 or during interval t2, this means that there is no bit equal to 0 and no bit equal to 1; in other words, it means that there are no longer any tags in the electromagnetic field of the query device and that this query device stops the process in a step 12.

Otherwise, if the bits are sent at time t1 and/or at time t2, the process continues by a test step 13 that consists of checking if there were any responses in the two intervals t1 and t2. If there were responses only in one of the two intervals t1 or t2, then it is considered that there are still potentially just as many tags and the value of the code bit with this rank is known as a function of the response that was either in interval t1 or in interval t2. In this case, the order number NO of the tag or the group of tags with the same first bit is zero (step 14).

If the query device detects different bits, in other words bits equal to 1 and bits equal to 0, the group of tags that responded in time interval t1 is assigned order number 0 and the other group is assigned order number 1 (step 15).

The process then continues with a step 16 to update the codes as a function of the values of the previously identified bits. This update to the codes forms the beginning of the creation of the real list containing parts of tag codes already detected, and order numbers that are assigned to each of the tags as far as the bit rank being processed.

When the first bit rank has been processed, a step 17 consists of incrementing the bit rank k to go onto the next bit rank k+1, and then reading this new bit rank k+1.

The read bit rank step 17 consists of querying the tags about the bit value at this bit rank k+1. If the query device does not detect any response on interval t1 or on interval t2, it deduces that there are no longer-any tags in the electromagnetic field and that reading is finished (step 18).

On the other hand, if the query device detects responses, the process continues with a test step 19 that consists of checking if all detected bits are identical.

If they are, then it is deduced that there is still potentially the same number of tags; the order number NO calculated by each tag or group of tags for which the code is the same as far as the bit rank considered, remains the same; the value of the bit code at this bit rank is determined unambiguously. The real list of detected codes (in other words the part of codes already detected) is updated (step 22).

The process according to the invention determined an order number for each tag, as far as bit rank k. These order numbers were built up to be consecutive, such that the query device knows the number of tags present in the electromagnetic field when the query cycle was started, at all times. These order numbers are included between 0 and NE−1, where NE is the number of tags or the number of groups of tags with the same code part as far as this bit rank k.

If the response to test 19 is no, in other words in the case in which there were responses on interval t1 and on interval t2 at the same time, then it is considered that there are more groups of possible tags than groups of tags that have been detected as far as this bit rank, and the query device starts a specific phase in order to specify this new information and clear the ambiguity due to the collision.

If a collision is detected, then the process proposes to carry out a code expansion step in which it is considered that there are at least two possibilities of different and additional codes; at this level, the order number NO is even by construction.

In other words, the process according to the invention draws up a hypothetical list of all possible cases for the new bit rank and tests all possible assumptions of bits included in this list. To achieve this, the process consists of making the conservative assumption that there are potentially twice as many tags or groups of tags present as the number of groups of tags that have been detected up to this moment. The ambiguity is due to the lack of information at this level about the node in the binary tree, in which there is actually a fork to be taken into account. There are potentially two possible solutions at each node in the tree, in other words a bit equal to 0 and a bit equal to 1 for the next bit rank.

Thus, the process according to the invention uses the variation of the order numbers to take account of this conservative assumption. More precisely, if the order number of the tag was equal to k, then its order number becomes 2k plus the assumed value of the next bit (step 20).

It will be seen that the expansion phase is useless in the case of a collision in the first bit rank (in other words in bit rank 0); there is no ambiguity, since it is known that there are at least two tags for which the code begins with a 0 for the first and with a 1 for the second. Therefore, the assigned order numbers are necessarily 0 and 1.

The process then consists of updating all codes identified as far as this rank k, in step 21. More precisely, the code becomes:

code already detected+bitₖ×2^{(N-k-1)}

if the detection is made starting from the highest order bit or

code already detected+bitₖ×2^{(k-1)},

if the detection is made starting from the lowest order bit.

In other words, step 21 consists of validating the assumptions made during the code expansion step (step 20). To achieve this, the query device sends a call on all order numbers, and for the rest of the process only keeps the tags that responded that they were present at this call.

More precisely, the step to call order numbers begins with a specific message sent by the query device, to all tags. Each tag responds with a beep when it is its turn to be called, in the order of the order numbers. If a tag is missing, it does not send a beep, and then the query device systematically returns information after the response from each tag, to indicate whether or not the tag is present. If there is no response from a tag, the tags for which the order number is greater than the order number that did not respond, decrements their order number by 1. These order numbers are thus updated until the next call.

When a call phase has begun, the tags use the order numbers that they had at the beginning of this phase to identify the time interval within which they must respond.

Furthermore, the tags update their own order number.

Order numbers are updated by all tags, making sure that they are distinct for each different code, but identical for tags that have the same code start. They are updated to make them consecutive, one after the other.

Furthermore, since the query device systematically returns information about whether or not each tag is present, the tags therefore have all information that they need to calculate the codes of all other tags if necessary, and/or the total number of tags present in the electromagnetic field of the query device.

The process according to the invention then continues with step 23, which is a step to check if all bit ranks have actually been processed. If not, then the process resumes at step 17, in which the bit rank k is increased by 1. If, on the other hand, the query device detects that it was the last bit rank, then the query cycle terminates at step 24.

FIG. 3 shows a table containing an example in which six tags are queried. This table contains 14 columns each of which represents a time interval P1 to P14.

The first row of the table identifies the sender. During type L intervals, the query device sends messages to the tags; during E type intervals, the query device receives messages from the tags. More precisely, during interval P1, the reader (or query device) sends a start message meaning that the read codes cycle begins. The other messages sent by the query device are either the VBEEP message to indicate that the reader has seen a response beep from the tags, or the NVBEEP message to indicate that the reader did not see any beep. Each of these messages, VBEEP and NVBEEP, is sent after an interval E during which the queried tags can respond.

In the table shown in FIG. 3, the third, fifth, seventh, ninth, eleventh and thirteenth rows represent responses or lack of responses from each tag. The third row in the table represents signals sent by the first tag for which the order number is 0 (denoted Tag NO=0). The next row entitled MAJNO shows the value of the next order number. The following rows show the other hypothetical tags with order numbers 1, 2, 3, 4 and 5, in each case showing the row indicating the value that will be assigned the next order number underneath.

This table shows that the tag for which the order number NO is 0 sends a beep at interval P2. The next tag for which the order number is equal to 1 does not send a beep at interval P4, which shows that it does not exist. The tag NO=2 then sends a beep at interval P6. But since tag NO=1 does not exist, the order number of tag NO=2 is decremented by 1, and therefore tag NO=2 is assigned number 1 as the next order number. Consequently, the tag that initially had order number NO=3 then becomes order number 2.

The next tag, for which the initial order number NO was equal to 4, also does not respond within period P10, which implies that the tag for which the order number NO was initially equal to 5 (and which had become 4 because there was no response from tag 1) becomes equal to order number 3 in period P12.

When all order numbers have been updated, the list of codes is also updated as a function of the remaining tags, in other words tags that responded with a beep when the call was made by the query device.

The process according to the invention may include an additional step which consists of checking that all these tags have been correctly detected at the end of the process, when all tags have been detected. Since the total number of tags is known and each tag has a unique and consecutive order number, it is possible to make a call, and for each tag to respond with its identification code, in order to check that all tags are correctly detected.

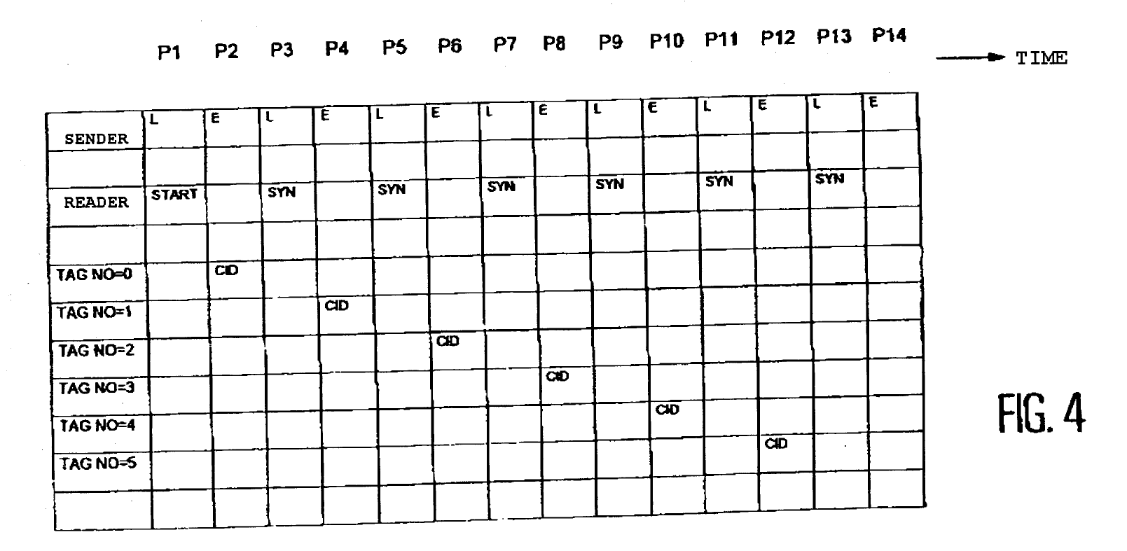

FIG. 4 contains a table of the type shown in FIG. 3, showing the variation as a function of the periods P of the dialogue initiated between the query device and the tags. As shown in FIG. 3, the first row in the table identifies the sender, in which:

the letter L means that it is a period during which the query device is sending a message; either START which means that it is the beginning of the verification cycle, or SYN which means that the next tag can send its code; and

the letter E corresponds to a period during which the tags send their identification code.

Thus, throughout period P1, the query device sends the START message to start the verification phase. The first tag for which the order number is NO=0, responds by giving its identification code, denoted CID on the table. Then during period P3, the query device sends a message SYN which indicates that the next tag should send its code; during period P4, tag NO=1 sends its identification code; then during period P5, the query device resends a SYN message and the next tag order number 2 sends its code. This process continues as far as period P12, in which the tag with order number 5 sends its code.

Finally, in interval P13, the query device resends a single message requesting the next tag to send its code; at this stage there are no more tags, in other words there are no tags with order number 6, and therefore the verification phase stops.

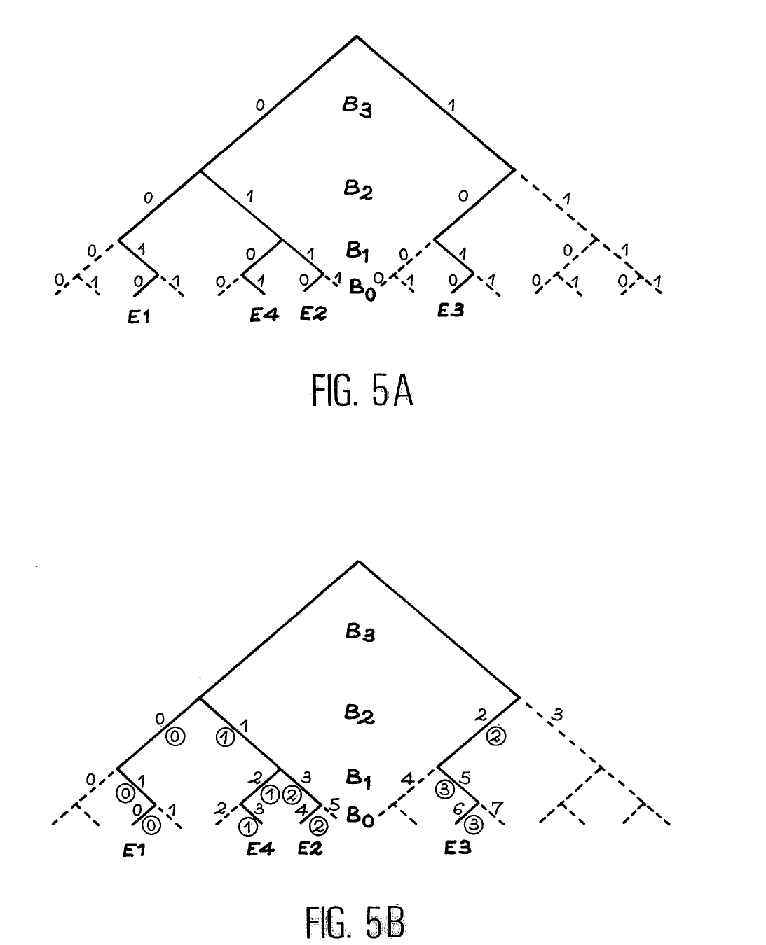

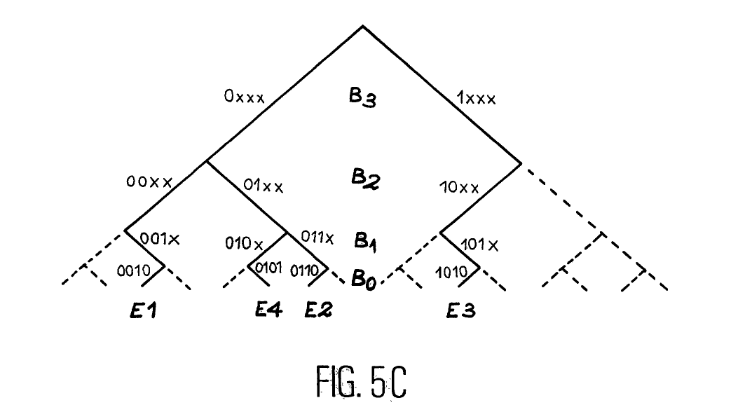

FIGS. 5A to 5C show an example of a tree structure search to determine the identification codes for four tags called E1, E2, E3 and E4, each comprising 4 bits. The code of tag E1 is 0010, of tag E2 is 0110, of tag E3 is 1010 and of tag E4 is 0101. These 4-bit codes will more generally be denoted B₃, B₂, B₁, B₀, where B₃ is the highest order bit and B₀is the lowest order bit.

FIG. 5A shows the tree structure built up starting from the highest order bit, namely B₃, and then breaking down the code as far as the lowest order bit, namely B₀. In this figure, all possible binary values are represented by a dashed line, and the path followed along the tree to determine the identification code of these four tags E1 to E4 is shown as a solid line.

FIG. 5C shows the same binary tree structure, in which the variations of the identification codes are shown.

Thus, during the query of the first bit rank, the codes Oxxx and 1xxx were determined where xxx necessarily represent bits that have not yet been identified. In the second bit rank, in other words bit rank B2, the codes 00xx, 01xx and 10xx were identified. In the third bit rank, in other words bit rank B1, the process identified codes 001x, 010x, 011x and 101x. In the fourth bit rank, in other words the last bit rank for the example shown in FIG. 5, the identified codes are 0010 corresponding to tag E1, 0101 corresponding to tag E4, 0110 corresponding to tag E2 and 1010 corresponding to tag E3.

FIG. 5B shows the variation of the order numbers during the tree structure search. In order to better understand this variation, a normal number was used to denote the order number hypothetically assigned to each possible code, in other words assigned during the code expansion step 20, and numbers surrounded by circles are the real order numbers that will be actually assigned to each tag after the call made by the query device (step 21). Thus, it can be seen that for the first bit rank, namely bit B₃, there are necessarily two possibilities and therefore no ambiguity on the order numbers, as described above. In the second bit rank, namely bit B₂, the query device assigns an order number (0, 1, 2 and 3) to each possibility of a new code, using a hypothetical list. When detecting bits (see FIGS. 5A and 5C), it is found that no tag corresponds to order number 3, therefore the process updates the order numbers of the tags actually present. Therefore these order numbers are 0, 1 and 2 for the parts of the codes detected in the second bit rank. For the third bit rank, namely B₁, the process hypothetically assigns order numbers 0 to 5. When tags are called, the order numbers are updated from 0 to 3, since there are no tags that correspond to the hypothetical order numbers 0 and 4. Similarly, for the fourth bit rank, it is seen that the real order numbers assigned to the tags are 0 for tag E1, 1 for tag E4, 2 for tag E2 and 3 for tag E3.

According to one embodiment of the invention, order numbers are not called systematically; the call can be made only when there is a risk of overflow, either because of the size of the order numbers which may be limited due to the electronics used in the tag, or because of the hypothetical list of identification codes managed by the query device.

The process according to the invention that has just been described is used by a system comprising firstly a query device and secondly a set of tags.

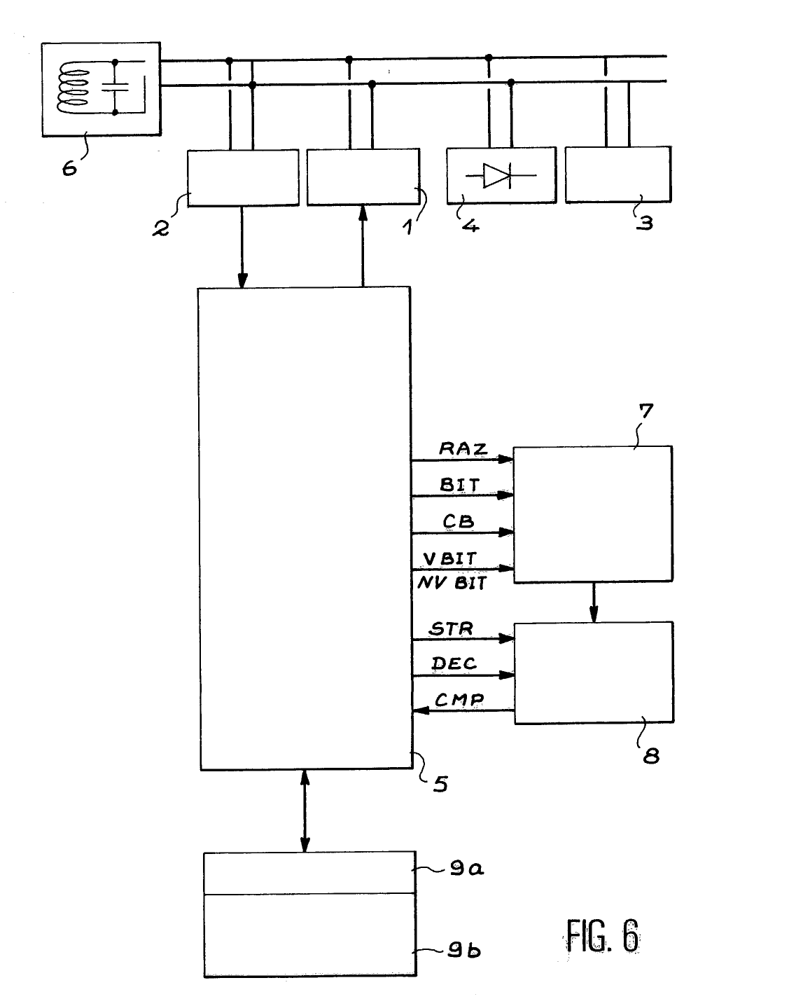

FIG. 6 shows an example architecture of one of these tags. This tag comprises an electromagnetic transmission means 6, and electronic modulation means 1 and demodulation means 2 that enable it to communicate binary information to the query device, or to receive binary information from this query device. Furthermore, each tag comprises electronic energy recovery means 4, and clock extraction means 3, these means 3 and 4 being necessary since the tag is passive. These means 1, 2, 3, 4 and 6 are already described in patent application FR-A-2 677 135; therefore, they will not be described in more detail in this application.

Each tag also comprises electronic means 5 called “sequencers”, that are used to sequence a set of actions to be undertaken as a function of messages received from the query device, and means of temporary or permanent information storage denoted 9a and 9b. These storage means comprise firstly a memory reference 9a that will contain the identification code, and a storage memory reference 9b that will be used to store information related to the application or the application field.

This tag also comprises an order number management logic reference 7, for which the role is:

in a bit collision phase, to calculate the hypothetical order number using the code expansion formula, namely n=>2×n+value of the bit of the current rank of the tag; and

during the call phase, to decrement the order number by 1, if a tag with a lower order number is detected as being non-existent.

Each tag also comprises an order number register reference 8, the role of which is to store the value of the order number during the call phase. The logic for order 7 numbers and the register for order 8 numbers are directly related to each other.

A counter used with the register for order 8 numbers is used to determine the interval within which the tag must respond as being present during a call sequence.

The logic for order 7 numbers receives information from the sequencer about a reset (RAZ), a bit rank (BIT), collision information (CB) and the VBEEP and NVBEEP signals indicating that the query device, did see or did not see the bit, respectively. The register for order 8 numbers also receives two items of information from the sequencer 5, namely the STR information which means that an order number was transferred to the counter and the DEC information dealing with release of the order number. The register for order 8 numbers sends comparison information CMP to the sequencer 5, which means that the tag should send since its order number is equal to 0.

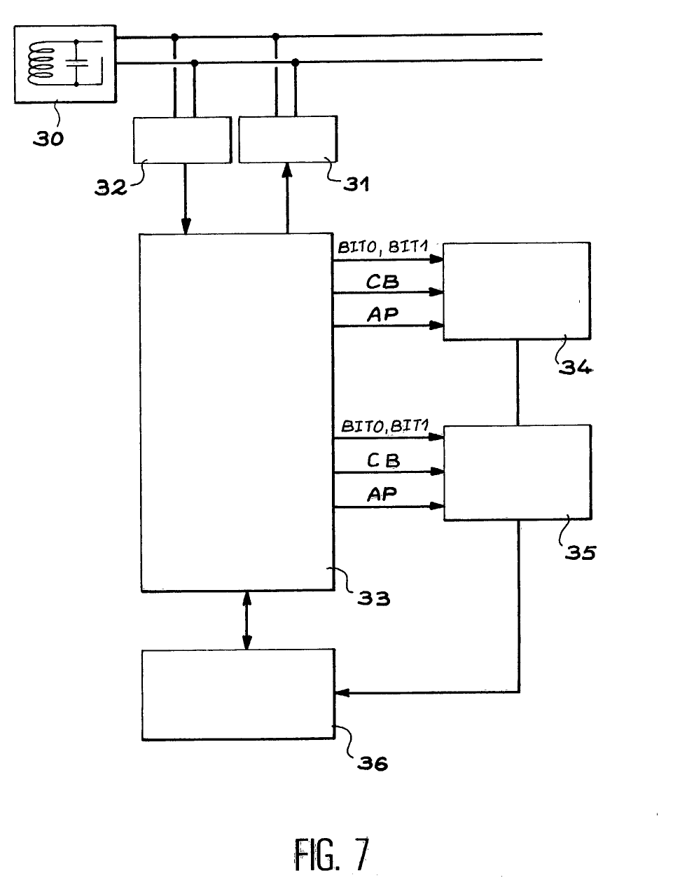

FIG. 7 diagrammatically shows the architecture of a query device like that used in the system according to the invention. This query device comprises electromagnetic transmission means reference 30, and electronic modulation means 31 and demodulation means 32 that it uses to communicate binary information to the set of tags, or to receive binary information from these tags. This query device also comprises a sequencer 33, the role of which is to sequence a set of actions to be undertaken as a function of messages received from the tags. The query device also comprises temporary or permanent information storage means reference 36. In particular, these storage means 36 comprise a list of codes being identified LCOD, which is the real list of codes, or parts of codes that have already been detected associated with the order number assigned to each of the tags. More precisely, this real list of detected codes is a memory area in which the query device stores and orders the code or part of the code that has already been detected. This storage is done dynamically in the sense that a tag may be taken out of the magnetic field of the query device at any time. Therefore, codes can be deleted from this list.

The query device according to the invention also comprises an order number management logic reference 34, the role of which is to calculate the order number during two successive phases:

during the bit collision phase: the number of NE order numbers is calculated as NE=>2×NE;

during the call phase: the number of order numbers NE is decremented by 1 if a tag with a lower order number is missing.

This management logic 34 receives information from the sequencer 33, namely information about the value of the bit 0 or 1, information about the presence of a bit collision, and information about the call phase.

The query device also comprises a code calculation logic 35 that receives the number of NE order numbers calculated by the register 35, from the order number calculation logic 34. The register 35 calculates the codes and resends the code thus calculated to the codes list 36.

1. Process for reading a set of electronic tags, each comprising a distinct identification code with N bits located within the electromagnetic field of a query device, characterized in that it consists of simultaneously identifying the codes of all tags present in the electromagnetic field, by determining the N bits of the identification codes, bit rank by bit rank.

2. Process according to claim 1, characterized in that it consists of:
for each bit rank k, querying all tags to set up a hypothetical list of codes containing all possible codes for bit rank k, these possible codes being built up starting from bits determined during queries of ranks less than k, and two possible sets of the value of the bits for rank k; and
after each query, producing a real list produced for all tags that responded to the query.

3. Process according to claim 2, characterised in that the real list is produced by calling tags in the hypothetical list.

4. Process according to either of claims 2 and 3, characterised in that the real list comprises the bits of the codes determined during queries in ranks less than k, and an order number, for each tag.

5. Process according to claim 4, characterised in that the order numbers are consecutive with each other.

6. Process according to one of claims 4 or 5, characterised in that the tag order numbers are updated as the bits of the identification codes are detected.

7. Process according to any one of claims 2 to 6, characterised in that after all tags present in the electromagnetic field have been detected, it consists of verifying the identification codes detected by calling all previously listed tags.

8. Process according to claim 7, characterised in that all previously listed tags are called using order numbers.

9. System for reading a set of tags by a query device, the tags and the query device each comprising means of sending/receiving signals, and sequencing means and storage means, the tags comprising means of calculating and managing order numbers, and means of storing order numbers, characterised in that the query device also comprises means of managing global queries for all tags, and means of calculating the tag order number, at each bit rank.
